(19) United States
(12) Patent Application Publication
(10) Pub. No.: US 2004/0174246 A1
(43) Pub. Date: Sep. 9, 2004

(54) Vehicle mounted remote door opening system

(76) Inventor: Vincent Mitchell, Leesburg, VA (US)

Correspondence Address: Vincent R. Mitchell, 43244 Cavell Ct., Leesburg, VA, 20176, US

(21) Appl. No.: 10/377,983

(22) Filed: Mar. 3, 2003

(51) Int. Cl. G06F 7/04

(52) U.S. Cl. 340/5.64; 340/5.72

(57) ABSTRACT

A system used to open a vehicle door consisting of a multiple radio frequency transmitter and a similarly coded radio frequency “RF” receiver. Said receiver is capable of generating a momentary RF trigger signal when a valid coded radio frequency signal is received. The system also incorporates a control switch connected to a vehicle transmission shift sensor that will produce an in-park signal when the vehicle's transmission is in park and a controlled on/off switch that will produce an on signal when the switch is in the on position. A control circuit will produce a ready signal when said in-park and on signals are present that is used to enable a door latch release circuit and activate a status indicator. The system will operate a bi-directional electric solenoid to operate a vehicle door latch mechanism in a direction necessary to open a vehicle door when said ready signal and RF trigger signals are present. The system will reverse the operation of said electric solenoid a short time after said operation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention relates to the field of remote door opening devices for automotive vehicles as a means for allowing law enforcement, military, emergency service, or other canine handlers the ability to remotely open a vehicle door and allow rapid deployment of a canine out from inside a vehicle. Many law enforcement agencies, private security companies, and military organizations have found the use of trained canines advantageous to track, disable, or detain suspects. With this canine use, such organizations will transport a canine with a handler on patrol within a variety of vehicle types. The most common type of vehicle used is the Police Pursuit Crown Victoria manufactured by the Ford Motor Company. Other vehicles used in this capacity include a variety of sport utility vehicles, pick-up trucks, vans, or sedans. The use of a remote door opening system helps police departments lower the liability potential of an unwanted dog bite by keeping the canine contained inside the patrol vehicle until a situation occurs requiring their use. At such a time as the canine is required, the handler can utilize a remote transmitter to signal at a distance the door to open and the canine to deploy. The first use of a remote canine deployment system consisted of a remote controller connected to the power window circuit(s) of a vehicle. When the canine was required a handler would trigger via radio frequency the window(s) to roll down and the canine would jump out. It was soon realized that a canine is more prone to injury when jumping from the window of the vehicle. In addition, not all vehicles are equipped with power windows. The use of window drop type canine deployment systems was replaced in the late 1980s by the use of RF remote door openers by innovative police fleet maintenance technicians at the request of canine handling police officers. Word spread about the remote door opener concept to other departments and soon several manufactures were offering a version of the system, all which incorporated the same basic features. These common features are, a single channel radio frequency (RF) transmitter carried by the handler that when activated will send a coded RF signal to a vehicle mounted, similarly coded RF receiver. The receiver will then send an output that will activate a uni-directional (single direction, pull type) solenoid in the selected door, which will in turn, pull the door mechanism that releases the door latch so that the door will open. A spring or gas charged strut mounted to the door is typically used to push open the door and allow the canine room to exit. This type of door opening system has been utilized by law enforcement agencies since the late 1980s and the concept is common knowledge to both it's users and manufactures as the first developers made no effort to claim rights to their invention.

The present invention incorporates numerous design and operational improvements to those other remote door-opening system designs. (Prior art for this type of invention can be seen in U.S. Pat. Nos. 6,283,535; 6,145,917; 6,087,794; 5,557,888; 5,531,498; 5,332,279;

### SUMMARY OF THE INVENTION

The present invention provides the means to remotely open a vehicle door and allow a canine contained inside the vehicle to be deployed quickly. The present invention incorporates numerous improvements to existing door opening systems in regards to user, installer, and operational features.

The first improvement is regarding the type of radio frequency “RF” transmitter and receiver used. Prior inventions utilize an RF transmitter that sends a coded signal over a single RF channel to a similarly coded receiver. This type of single-channel RF transmitter can be prone to poor range or non-operation (signal jam) due to radio frequency interference “RFI” within the designated RF channel. The present invention incorporates an RF transmitter that sends coded signals across multiple channels to a similarly coded receiver. Using multiple RF channels will subsequently decrease the possibility of non-operation caused by signal jam. As a result of incorporating a multi-channel RF system, it was necessary to implement circuitry that would convert the incoming RF signal from a “through operation signal” to a “pulsed momentary output signal”. The reason for this conversion is that the multi-channel RF receiver could potentially output for three or more seconds while all channels are triggered. This length of the RF receiver output duration could shorten the life of or burn out the door solenoid by energizing it for to long. Most solenoids are designed to operate for approximately eight tenths of a second.

The second improvement is regarding the systems ability to detect when the vehicle's transmission is in the park position. This ability is necessary to prevent the system from accidentally opening the door while the vehicle is in motion. Prior inventions have relied on either finding a circuit within the vehicle's electronics that will supply a signal when the vehicle's transmission is in the park or neutral position or by utilizing an off-the-shelf “park siren kill module” which was originally designed to prevent a police siren form sounding when the vehicle is parked. The first of these two choices is difficult to implement as most vehicle electronics are now computerized and either do not supply such an output, or the output needs to be connected to in a specific fashion so as not to damage the computer control system(s). The second of these choices is a safer alternative as the companies that produce such “park siren kill modules” have performed sufficient research into many of the potential vehicle's electronics to produce an effective output. However, these “park siren kill modules” are expensive and continued research is required to maintain interoperability with any potential vehicle types year after year. The present invention incorporates a magnet and a magnetically activated switch that can be mounted to the shift mechanism of any vehicle to produce a signal when the vehicle is in park. Such magnetic switches are fairly inexpensive, reliable, and are compatible with all vehicles.

The third improvement is regarding the system on/off switch status indication. Prior inventions use a light emitting diode “LED” or other types of illuminated display to indicate when the door opening system is switched on. The status LED will remain illuminated until the system is switched off. Such an indicator can be a distraction to the driver while the vehicle is in motion or at night could act to further illuminate the interior of the vehicle and make the officer or passenger(s) inside a more visible target for a potential sniper. The present invention incorporates an LED which indicates the system is on by illuminating only when the system is switched on and the vehicle's transmission is in the park position.

The fourth improvement is regarding the type of solenoid used to release the door latch and allow the door to open. Prior inventions utilize a single directional solenoid that when energized “pulls” the door latch mechanism to release the door latch. This type of solenoid has two major shortcomings. Shortcoming one, installing the solenoid can be more difficult in vehicles whereby a pushing action is required to release the door latch as opposed to a pulling action and as mounting areas within the door are limited. Shortcoming two, many vehicles are made with a set spring that returns the factory door latch to the standby position after a door is manually opened “by hand”. The spring's operation can be hampered if additional drag is applied by an added component. If the latch does not fully return, the door lock mechanism can jam shut when engaged. The present invention incorporates a bi-directional door solenoid that can be used to generate a pull or a push motion to release the door latch mechanism. In addition, the present invention will reverse the operation after a short delay to return the door latch mechanism back to it's normal, at rest position, preventing the door locks from jamming.

### BRIEF DESCRIPTION OF DRAWINGS

FIG. 1 is a diagram illustrating multi-frequency benefits.

FIG. 2 is a diagram illustrating the RF Signal Cycle and the RF Receiver Output.

FIG. 3 is a diagram illustrating Inter-operational Component connections.

### DETAILED DESCRIPTION OF THE INVENTION

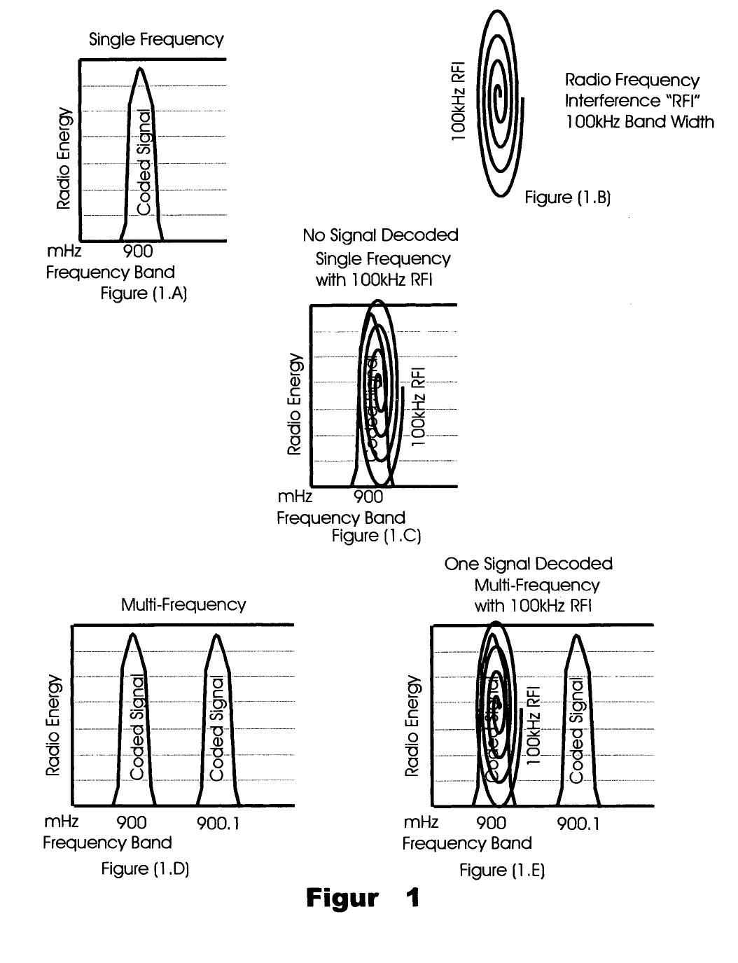

Proceeding therefore to describe the invention in detail, reference should be made to FIG. 1 in which the benefits of using multiple RF signals to trigger a door open signal are depicted. FIG. (1.A) represents the characteristics of prior existing system(s) that utilize a single RF signal to trigger the door to open. In FIG. (1.A) a coded RF signal is received and decoded and could be used as an output to generate a door open signal. FIG. (1.B) represents radio frequency interference “RFI” that measures across a 100 kHz frequency spectrum. FIG. (1.C) represents the previously described, single coded RF signal system (FIG. 1.A) with RFI present in the same time space and bandwidth as the single RF coded signal. In the case of FIG. (1.C) a valid signal decode output would not be generated and the door will not open as desired. FIG. (1.D) represents the characteristics of the present invention's claim to utilize multiple RF signals to trigger the door to open. FIG. (1.E) represents the previously stated RFI within the same time space and bandwidth present. In the case of FIG. (1.E) a valid signal decode output would be generated to open the door as desired. By incorporating a coded signal across an additional radio frequency, the probability of receiving a valid signal increases. Accordingly, the more prolific the use of radio frequencies is, the greater the possibility of a valid signal reception increases in relation.

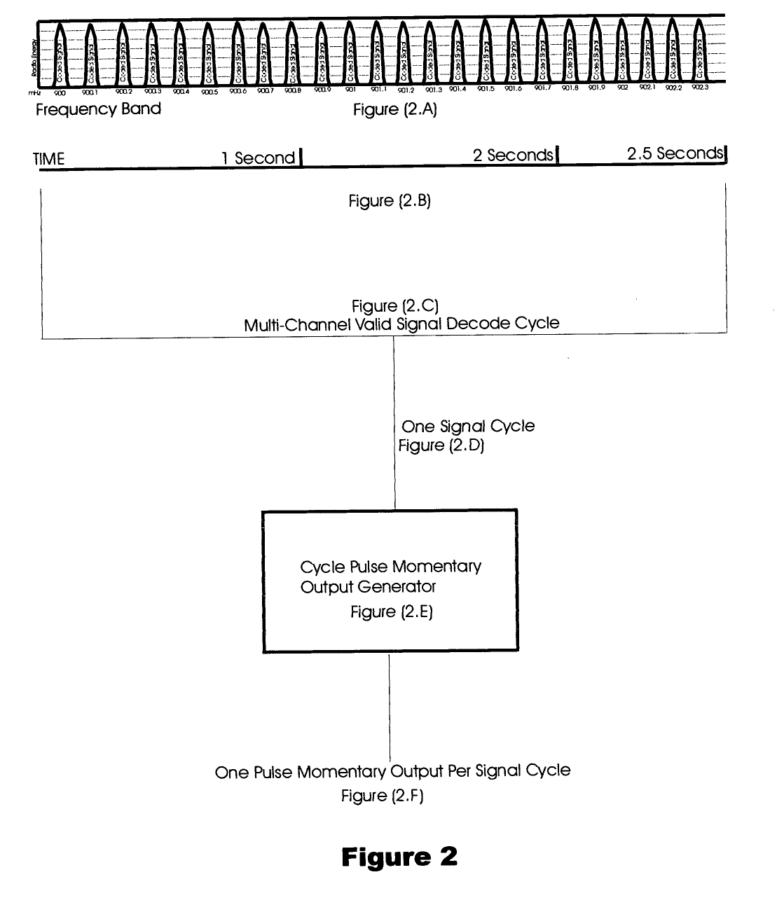

Further reference is made in FIG. 2 towards the present inventions use of multiple RF signals. In FIG. (2.A) a twenty-four channel, radio frequency transmission is depicted. In FIG. (2.B) a timeline is depicted in relationship to a complete RF transmission cycle as listed in FIG. (2.C). FIG. (2.D) represents one valid signal decode cycle from the RF receiver. The valid signal decode cycle could vary depending on the number of RF channels, frequency range, and signal format. For the purpose of depiction, the present invention shows RF use across radio frequencies starting at 900 mHz through 902.3 mHz with a cycle time of two and one half seconds. In FIG. (2.E) the receipt of the first valid decoded signal would trigger a timer. In the depicted case the timer would be set for 2.5 seconds. Per activation of the remote transmitter, all signals received stating with the first valid signal and continuing though the timed duration would be interpreted as one transmission cycle. For each transmission cycle with at least one valid signal, a pulsed switch momentary output will be generated as depicted in FIG. (2.F)

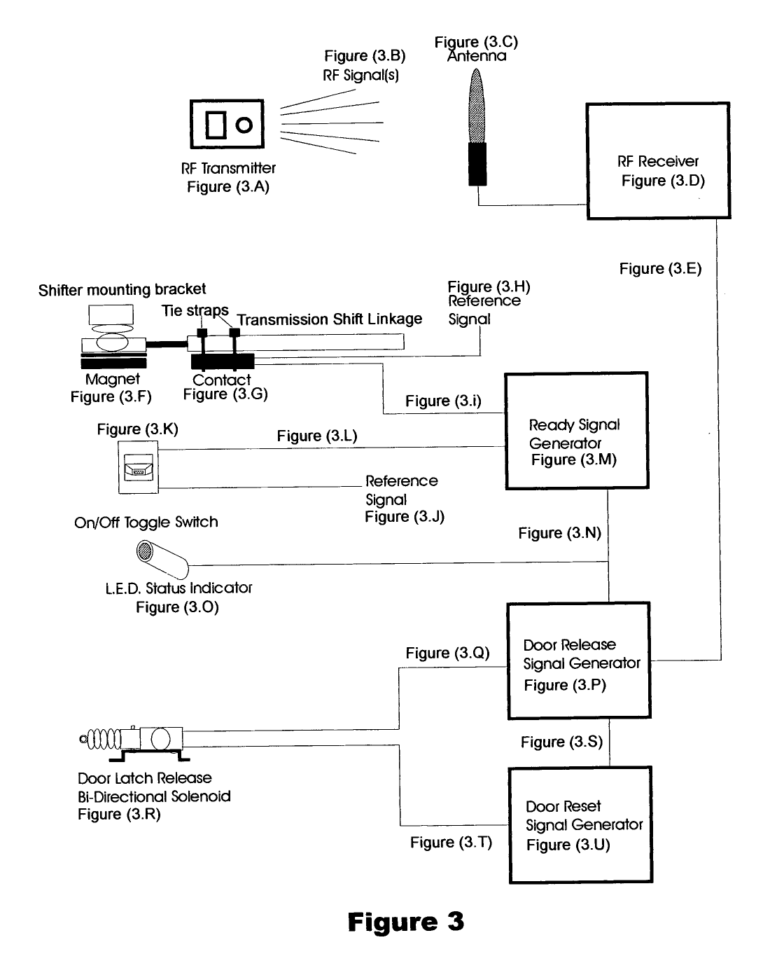

Further reference is made in FIG. 3 regarding the present inventions inter-operational component connections. FIG. (3.A) depicts a radio frequency transmitter capable of sending coded radio frequency signals across multiple radio frequency channels. FIG. (3.B) represents said multiple radio frequency signals as sent or transmitted. FIG. (3.C) represents a radio frequency antenna tuned to the required frequencies to receive said radio frequency signals from said RF transmitter. The RF receiver will receive and decode valid RF signals as depicted earlier in FIGS. 1 and FIGS. 2. FIG. (3.E) represents the pulsed switch momentary output as depicted in FIG. (2.F). FIG. (3.F) represents a magnet and FIG. (3.G) represents a magnetically controlled switch whereby a contact switches to the closed loop position within FIG. (3.G) when the magnet (3.F) is within range to activate the magnetic switch (3.G). The typical range of such a magnet and magnetic switch is approximately one half to two inches mounting gap. The magnet and the magnetic switch would be mounted on the mechanical linkage between the vehicle transmission shifter and the vehicle transmission in such fashion as to bring the magnet within range to the magnetic switch so as to activate the magnetic switch when the vehicle's transmission is in the park position. While the magnetic switch is activated, the reference signal input to the magnetic switch as depicted in FIG. (3.H) will be passed through the closed magnetic switch which will output an In-Park signal as represented in FIG. (3.I). When the vehicle's transmission is shifted out of park, the magnet will move out of range for the magnetic switch to close and the In-Park signal will not be generated. FIG. (3.J) represents a reference signal input to the On/Off toggle switch as depicted in FIG. (3.K). When the On/Off toggle switch is switched to the ON position, the reference signal input (3.J) will be passed through the On/Off switch which will output an On signal as represented by FIG. (3.L). FIG. (3.M) represents the ready signal generator circuit in which a ready signal output represented in FIG. (3.N) is generated if the In-Park signal FIG. (3.I) and the On signal FIG. (3.L) are both present. FIG. (3.O) represents an L.E.D. status indicator which connects to the ready signal output FIG. (3.N) so as to illuminate when said ready signal is present. FIG. (3.P) represents the door open signal generator circuit that will generate two isolated door open signal(s) FIG. (3.Q) and FIG. (3.S) if the ready signal FIG. (3.N) and the pulse switch momentary output FIG. (3.E) are present. The door open signal will cause the door solenoid motor depicted in FIG. (3.R) to operate in one direction. FIG. (3. U) represents the door reset generator circuit that will generate a door reset signal FIG. (3. T) after the door open signal is generated and a predetermined amount of time has elapsed. The door reset signal will cause the door solenoid motor depicted in FIG. (3.R) to operate in a direction opposite of the door open direction. To reverse the operational direction of the door solenoid the solenoid connections at FIG. (3.Q) and FIG. (3.T) can be exchanged so that the wire typically associated with FIG. (3.Q) is now connected to FIG. (3.T) and the wire typically associated with FIG. (3.T) is now connected to FIG. (3.Q)

What is claimed is:

1. A means for opening a vehicle door remotely comprising;
A, a radio frequency transmitter capable of sending a cycle of coded signals across multiple frequency channels, and
B, a radio frequency receiver similarly coded to the radio frequency transmitter and capable of generating a controlled switch circuit cycle signal corresponding to the RF receiver decoding the reception of the first through the last of such coded signals across multiple frequency channels in a cycle, and
C, a pulse switch circuit operatively connected to said RF receiver controlled switch circuit cycle signal that generates one momentary output signal for each cycle, and

2. A, a magnetic switch that generates an in-park controlled output signal when a magnet is within range to activate the magnetic switch due to the vehicle's transmission shifted in the park position, and

3. A, a toggle switch that generates a controlled output signal when said toggle switch is in the On position, and
B, a controlled switch circuit operatively connected to said in-park controlled output signal and said toggle switch output signal whereby a system ready output is generated if said toggle switch On output signal is present and said in-park controlled output signal is present, and

4. A, a pulse switch circuit operatively connected to said RF pulse switch momentary output signal and said in-park controlled output signal whereby a momentary door release output signal is generated and a timer controlled switch output signal is generated for a predetermined length of time if said RF pulse switch momentary output is present and said in-park controlled output signal is present, and
B, a pulse switch circuit operatively connected to said timer controlled output signal whereby a reset pulse switch output signal is generated upon release of said timer controlled output signal, and
C, a bi-directional electronic solenoid operatively connected to said door release pulse output signal and said reset pulse signal whereby said electronic solenoid will operate in one direction when said pulse door release signal is present and said solenoid will operate in the opposite direction when said pulse reset signal is present.
